(19) United States
(12) Patent Application Publication
(10) Pub. No.: US 2023/0241565 A1
(43) Pub. Date: Aug. 3, 2023

(54) FEED MIXER WITH IMPROVED MIXING AUGER

(71) Applicant: TRIOLIET B.V., Oldenzaal (NL)

(72) Inventor: Robert Jan LIET, Oldenzaal (NL)

(21) Appl. No.: 18/104,486

(22) Filed: Feb. 1, 2023

(30) Foreign Application Priority Data
Feb. 2, 2022 (DE) 20 2022 100 590

(51) Int. Cl. B01F 27/9212; B01F 27/922; B01F 33/502; A23N 17/00

(52) U.S. Cl. CPC B01F 27/9212; B01F 27/922; B01F 33/5023; A23N 17/007; B01F 2101/18

(57) ABSTRACT

The invention provides a feed mixer for mixing feed including a mixing container for receiving feed, wherein the mixing container has a bottom and a wall extending upwardly from the bottom, wherein the mixing container includes at least one mixing auger rotatably arranged in the mixing container, wherein the at least one mixing auger is rotatably drivable about a vertical axis, characterized in that the pitch of the at least one mixing auger increases upwardly.

### CROSS-REFERENCE TO RELATED APPLICATIONS

This application claims priority to German Application No. DE 20 2022 100 590, filed Feb. 2, 2022, the disclosure of which is incorporated herein by reference.

### FIELD OF THE DISCLOSURE

The invention relates to a feed mixer for mixing feed according to a preamble of claim 1.

### BACKGROUND

Feed mixers are becoming increasingly common in agriculture and include a mixing container, in which at least one mixing tool is moved to mix feed. The mixing container typically includes a bottom and a substantially conically flaring front wall and rear wall, and generally flattened side walls. Further, the mixing container is open at its upwardly facing side so that it can be loaded through this opening. The mixing tool is usually configured as a mixing auger, which tapers towards the top and is driven around a vertical axis in such a way that the filled feed is conveyed upwards and flows back to the bottom of the mixing container, where it is again fed to the mixing tool. In this way, the feed is mixed and loosened. Such a feed mixer is known, for example, from EP 1 527 678 A1.

In known feed mixers, the pitch of the mixing augers used is constant.

Although known feed mixers allow a good mixing, the loosening of the feed is sometimes not satisfactory.

It is therefore the object of the invention to provide a feed mixer of the type mentioned above, which ensures better loosening of the feed.

This object is solved by a feed mixer according to claim 1. Advantageous further embodiments are defined in the dependent claims.

### SUMMARY

The invention thus provides a feed mixer for mixing feed, including a mixing container for receiving feed, wherein the mixing container has a bottom and a wall extending upwardly from the bottom, wherein the mixing container includes at least one mixing auger rotatably arranged in the mixing container, wherein the at least one mixing auger is rotatably drivable about a vertical axis, and the pitch of the at least one mixing auger increases upwardly.

It has been shown that such a mixing auger introduces more air into the feed as the feed is transported upwardly, resulting in better loosening of the feed. It has also been shown that such a mixing auger may transport more feed under the same conditions, thus enabling faster mixing and, if necessary, cutting of the feed.

In particular, more than one mixing auger may be provided, for example two or three mixing augers. The features described below for one mixing auger may apply in particular to all mixing augers in the case of feed mixers with several mixing augers. However, it is also conceivable that mixing augers of a feed mixer are configured differently.

The wall extending upwardly from the bottom may include, in particular, a front wall, a rear wall and two side walls as viewed in the direction of travel. The front wall and the rear wall may widen conically upwardly. The side walls may include flattenings. The flattenings allow narrower barn aisles to be traversed.

As used herein, the term “pitch” indicates the distance, by which the auger thread of the mixing auger winds upwardly after a rotation through a predetermined angle, in particular a 180° or a 360° rotation. In this context, “rotation” may be understood as an imaginary displacement of a point of the auger thread along the auger thread by the predetermined angle. In particular, the pitch may also be specified continuously. In other words, for each point of the thread, a pitch may be specified as the distance, by which the auger thread has wound upwards after a predetermined rotation to that point, in particular a 180° or a 360° rotation. For the comparison of two or more values for the pitch, the same rotation is used to determine the respective pitch. The pitch may in particular also be referred to as “lead” or “slope”.

The pitch of the mixing auger may increase or vary upwardly in particular such that at least one pitch is greater than one or more, in particular all, of the pitches below it. In particular, each pitch of the mixing auger may be greater than all of the underlying pitches.

In particular, the pitch may increase steadily and/or incrementally. In the case of a steady or continuous increase, particularly uniform mixing may take place. A stepwise increase may be simpler in terms of design. In the case of a stepwise increase, in particular one or more turns with a first pitch and, above this, one or more turns with a second, larger pitch may be provided. The pitch may also increase steadily in sections and incrementally in sections.

In particular, the increase of the pitch may be in one or more steps.

If the mixing auger winds upwards by 360 degrees, this is also referred to as a turn. The pitch may also be regarded as the height of a turn. As a reference or zero line for the first turn, a straight line may be used herein that includes the transition of the auger thread to the bottom of the mixing chamber.

The mixing auger may include a simple helix. In other words, exactly one thread may be provided per mixing auger. In particular, therefore, in embodiments the mixing auger may not include a double helix, that is, in particular, it may not include a double-flight auger thread.

The central element of the mixing auger extending upwardly from the bottom of the mixing container may be referred to as the auger tower. The auger tower may constitute or include the shaft of the mixing auger. The auger tower may also be referred to as the auger shaft or auger tube. In particular, the auger blades may be attached to the auger tower. The auger blades may also be referred to as flanks.

The conveying volume of a mixing auger describes the maximum volume of space that can be transported upward by the mixing auger in one turn between oppositely arranged, facing auger blades of the mixing auger.

The cross-sectional area of the conveying volume may correspond to the cross-sectional area through the centerline of the auger tower, which is bounded by oppositely arranged, mutually facing auger blades, the connecting line of the outermost points of the auger blades and the shell of the auger tower.

The increase of the pitch of the at least one mixing auger may be 10-100%, in particular 20-80%, in particular 25-40%, for each turn. This makes it possible to achieve a particularly advantageous mixing result.

The at least one mixing auger may taper upwards. In other words, the outer radius or outer diameter of the at least one mixing auger may decrease upwards. In particular, the outer radius or outer diameter may decrease steadily or gradually.

In this case, the increase of the pitch may counteract in a compensating manner the tapering of the at least one mixing auger by increasing the pitch such that a cross-sectional area of the feed volume remains the same or increases. In this way, reduced compression of the feed during mixing may be obtained, so that an advantageous mixing result may be achieved.

The ratio of a maximum pitch to a minimum pitch of the at least one mixing auger may be between 1.2 and 6, in particular between 1.4 and 4, in particular between 1.5 and 3.

The auger blades of the at least one mixing auger may be flat or basin-shaped. The points of the auger blades that have the greatest radial distance from the auger tower may be used to determine the pitch. These points may be referred to as margin points or margin.

The feed mixer may be a robotic feed mixer, a feed mixer vehicle, or a stationary feed mixer. A feed mixer vehicle may be a device that is trailer-drawn or self-propelled. The feed mixer vehicle may include a discharge opening and a discharge conveyor so that feed may be discharged from the mixing chamber while the vehicle is in motion. A feed robot may also include a discharge opening and a discharge conveyor, such that feed from the mixing chamber may be discharged from the mixing chamber when driving. However, unlike a feed mixer vehicle, a feed robot moves in an automated manner along a predetermined or predeterminable path.

The auger tower of the at least one mixing auger may taper upwardly. In this way, in particular, the decrease in the width of the auger blades of the mixing auger, i.e. their radial extent, may be reduced upwards as the mixing auger tapers. In particular, the auger tower may taper steadily or gradually upward.

The invention also provides a feed mixer for mixing feed, including a mixing container for receiving feed, wherein the mixing container has a bottom and a wall extending upwardly from the bottom, wherein the mixing container includes at least one mixing auger rotatably arranged in the mixing container, wherein the at least one mixing auger is rotatably drivable about a vertical axis, and wherein the pitch of the at least one mixing auger is configured to be variable.

Variable may mean in particular that the pitch in at least one region of the auger thread is different from the pitch in at least one other region. Such variability may optimize the mixing result.

The feed mixer may thereby have one or more of the above features.

### BRIEF DESCRIPTION OF THE DRAWINGS

Further features and advantages of the invention are described below with reference to the exemplary figures. In the figures:

FIG. 1 shows a feed mixer vehicle in schematic representation in perspective plan view,

FIG. 2 shows an exemplary mixing auger in schematic representation,

FIG. 3 is a schematically illustrated mixing auger with a constant pitch,

FIG. 4 is a schematically illustrated mixing auger with the cross-sectional area of the conveying volume increasing towards the top,

FIG. 5 shows a schematic mixing auger with the cross-sectional area of the conveying volume decreasing towards the top, and

FIG. 6 shows a schematic feed mixer in side view looking into the mixing container.

### DETAILED DESCRIPTION OF THE DISCLOSURE

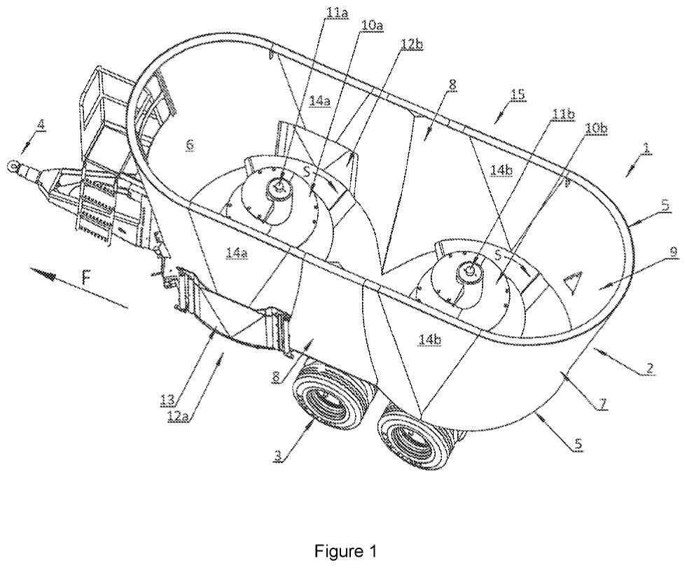

FIG. 1 shows a schematic diagram of a feed mixer 1 in perspective top view, which is configured as a feed mixer vehicle. The feed mixer 1 includes a mixing container 2 open at the top for receiving feed, which is mounted on a chassis 3 and may be moved in the direction of motion F by means of the drawbar 4, for example in a stable aisle, with the aid of a towing vehicle, such as a tractor. The mixing container 2 has a bottom 5, a front wall 6, a rear wall 7 and side walls 8. Front wall 6, rear wall 7 and side walls 8 together form the wall of the mixing container 2. Feed may be introduced into the mixing container 2 via the upper container opening 9. The feed to be mixed may in particular be long-fibered feed, such as silage or hay picked up by a loader wagon.

Two mixing augers 10a and 10b, respectively, arranged one behind the other in the direction of motion F are provided inside the mixing container 2. Each of the mixing augers 10a and 10b rotates in a rotary manner about a vertical axis 11a, 11b which is perpendicular to the floor 5. In other words, the mixing augers 10a and 10b are thus configured as vertical auger conveyors, vertical augers for short. The direction of rotation of the two mixing augers 10a, 10b is the same here and is in the direction of the arrow S here.

In addition to the mixing auger 10a at the front in the direction of motion F, there are two lateral discharge openings 12a and 12b, which are arranged at the height of the vertical axis 11a and diametrically opposite on both sides of the vertical axis 11a. The two discharge openings 12a and 12b break through the side walls 8 of the mixing container 2 and may each be closed by a slide 13.

During operation of the feed mixer, the feed is introduced into the mixing container 2 via the container opening 9. Due to the rotation of the two mixing augers in the same direction, the feed is transported upwards and flows downwards again at the upper end of the mixing auger. Feed that reaches one of the two open discharge openings 12a, 12b is continuously discharged through it.

The front wall 6 and the rear wall 7 extend obliquely upwardly outwardly, so that the container opening 9 is larger than the outline of the floor 5. The angle of inclination of the side walls 8 is greatest in extension of a connecting line between the axes of rotation 11a, 11b, which runs parallel to the direction of motion F, and decreases with increasing distance from this connecting line, until a triangular, laterally placed flattening 14a, 14b, which is flat, touches the floor 5 with its tip and extends substantially perpendicularly to the floor 5. The flattening 15 reduces the width of the mixing container 2 transverse to the direction of motion F to such an extent that even narrow barn aisles may be traversed.

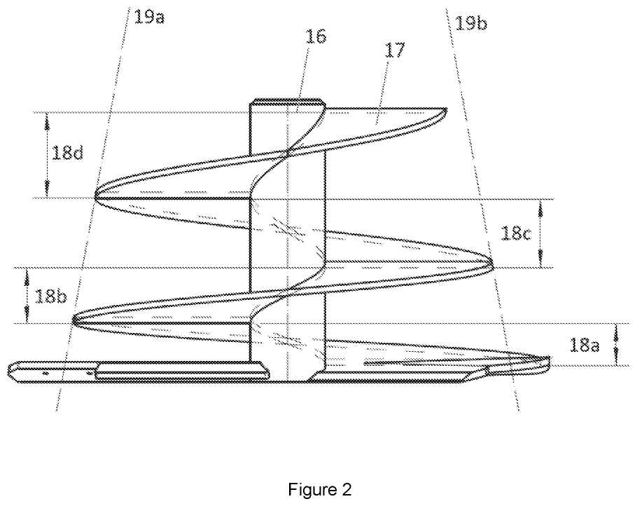

FIG. 2 shows a schematic illustration of a mixing auger according to the invention. The mixing auger has a tubular auger tower 16, to which the auger blades 17 of the auger thread are attached. The pitches 18a, 18b, 18c and 18d progressively increase every 180 degrees upwardly, each section being implemented by a sheet metal segment. Each of the pitches 18a, 18b, 18c, and 18d is greater than all of the pitches below it. For example, the pitches may be between 200 mm and 400 mm. Thus, a ratio of a maximum pitch to a minimum pitch would be 2. The upward taper of the mixing auger is indicated by dashed lines 19a and 19b.

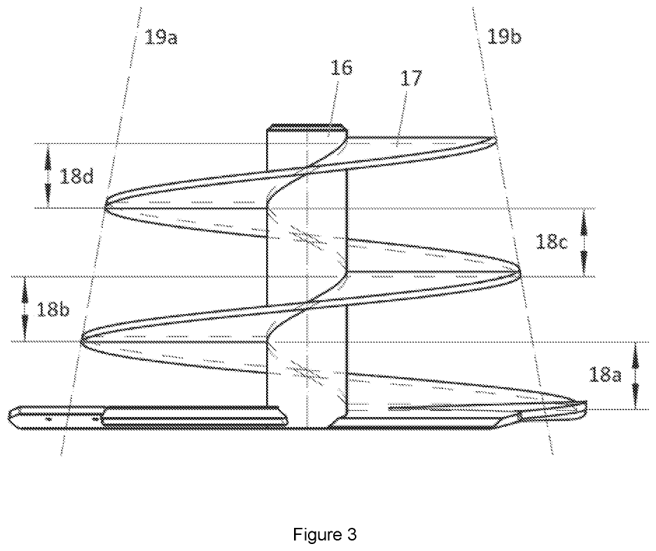

In comparison, FIG. 3 shows a schematic illustration of a mixing auger as known from the prior art, i.e. with constant pitches. The pitches 18a, 18b, 18c and 18d may, for example, all be 225 mm. The mixing auger has a tubular auger tower 16, to which the auger blades 17 are attached. The upward tapering of the mixing auger is also indicated here by dashed lines 19a and 19b.

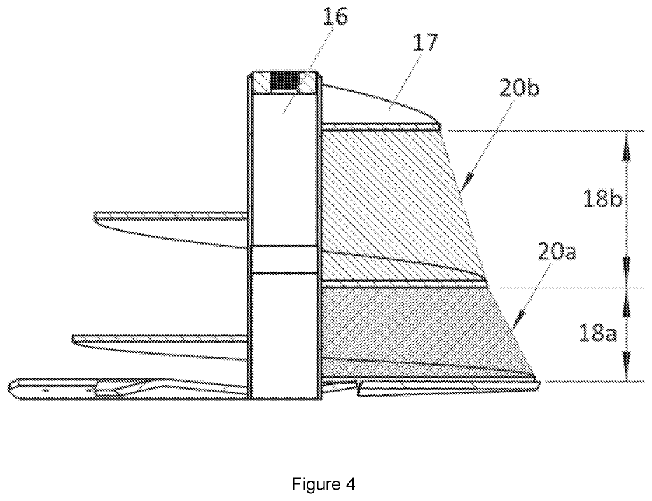

FIG. 4 shows a schematic cross-section through the auger tower 16 of a mixing auger with the pitch increasing upwards. The cross-sectional areas of the conveying volume are indicated by hatched areas 20a and 20b. The cross-sectional areas 20a and 20b with the corresponding pitches 18a and 18b increase upwardly and thus counteract the tapering of the mixing auger in a compensating manner. For example, the cross-sectional area 20a may be 2300 cm² and the cross-sectional area 20b may be 2900 cm². In other words, therefore, the conveying volume remains substantially constant or even increases upwardly, so that no feed flows prematurely from the mixing auger and thus a higher transport capacity of the mixing auger may be achieved and compression of the feed may be avoided. In addition, the additional volume may be used to loosen up the feed.

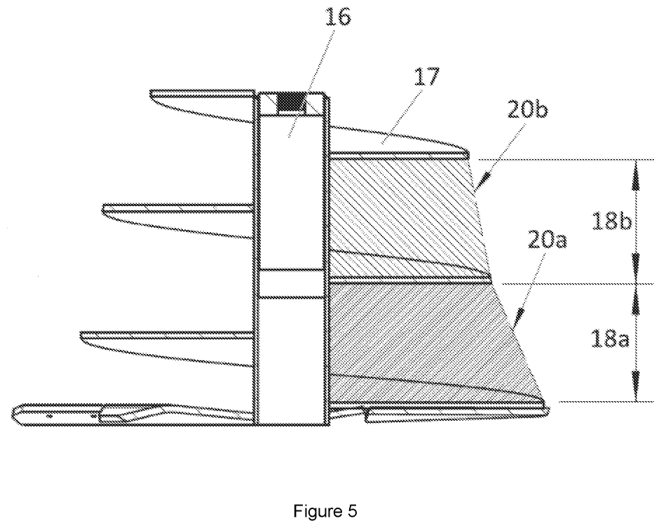

FIG. 5 shows a schematic cross-section through the auger tower 16 of the mixing auger of FIG. 3, i.e. a mixing auger known from the prior art. The cross-sectional areas of the feed volume are again indicated by hatched areas 20a and 20b. Due to the upward tapering of the mixing auger the cross-sectional area of the conveying volume decreases towards the top. The cross-sectional area 20a is smaller than the cross-sectional area 20b. For example, the cross-sectional area 20a may be 2950 cm² and the cross-sectional area 20b may be 2350 cm². Contrary to the mixing auger according to the invention, this results in a smaller transport capacity of the mixing auger and a compression of the feed.

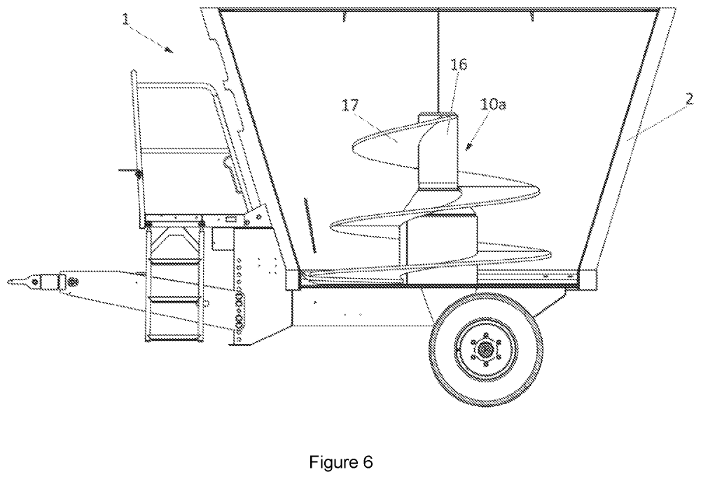

FIG. 6 shows a schematic feed mixer 1 in side view looking into the mixing container 2, wherein the mixing container 2 includes a mixing auger 10a according to the invention. The auger tower 16 of the mixing auger 10a tapers upwardly, so that the decrease in the width of the auger blades 17 upwardly may be counteracted by the tapering mixing auger 10a. As a result, a larger area of the auger conveyor may be provided, and thus a higher transport capacity may be obtained.

It is understood that features mentioned in the previously described embodiments are not limited to these particular combinations, and are also usable in any other combinations.

### LIST OF REFERENCE SIGNS

1 Feed mixer
2 Mixing container
3 Chassis
4 Drawbar
5 Bottom
6 Front wall
7 Rear wall
8 Side walls
9 Container opening
10a, 10b Mixing auger
11a, 11b Vertical axis
12a, 12b Discharge opening
13 Slider
14 Laterally placed flattening
15 Flattening
16 Auger tower
17 Auger blades
18a, 18b Pitch
19a, 19b Taper of mixing auger
20a, 20b Cross-sectional area of conveying volume
F Direction of motion
S Direction of rotation

What is claimed is:

1. A feed mixer for mixing feed comprising a mixing container for receiving feed,
wherein the mixing container has a bottom and a wall extending upwardly from the bottom,
wherein the mixing container comprises at least one mixing auger rotatably arranged in the mixing container,
wherein the at least one mixing auger is rotatably drivable about a vertical axis, and
characterized in that
the pitch of the at least one mixing auger increases upwardly.

2. The feed mixer according to claim 1, wherein the increase of the pitch of the at least one mixing auger is continuous and/or stepwise.

3. The feed mixer according to claim 1, wherein the pitch increases by 10-100%, by 20-80%, or by 25-40%, for each turn.

4. The feed mixer according to claim 1, wherein the at least one mixing auger tapers upwardly.

5. The feed mixer according to claim 4, wherein the increase of the pitch counteracts the tapering of the at least one mixing auger in a compensating manner due to increase of the pitch such that a cross-sectional area of the conveying volume remains the same or increases.

6. The feed mixer according to claim 1, wherein the ratio of a maximum pitch to a minimum pitch is between 1.2 and 6, between 1.4 and 4, or between 1.5 and 3.

7. The feed mixer according to claim 1, wherein the auger blades of the at least one mixing auger are flat or basin-shaped.

8. The feed mixer according to claim 1, wherein the feed mixer is a towed feed mixer vehicle, a self-propelled feed mixer vehicle, a feed robot, or a stationary feed mixer.

9. The feed mixer according to claim 1, wherein the auger tower of the at least one mixing auger tapers upwards.

10. A feed mixer for mixing feed, comprising a mixing container for receiving feed, wherein the mixing container has a bottom and a wall extending upwardly from the bottom, wherein the mixing container comprises at least one mixing auger rotatably arranged in the mixing container, and wherein the at least one mixing auger is rotatably drivable about a vertical axis,
characterized in that
the at least one mixing auger has a variable pitch.
